(19) United States
(12) Patent Application Publication
(10) Pub. No.: US 2020/0361470 A1
(43) Pub. Date: Nov. 19, 2020

(54) HYBRID VEHICLE AND METHOD OF CONTROLLING HYBRID VEHICLE

(71) Applicant: TOYOTA JIDOSHA KABUSHIKI KAISHA, Toyota-shi (JP)

(72) Inventors: Koichi YONEZAWA, Toyota-shi (JP); Satoshi Yoshizaki, Gotenba-shi (JP); Osamu Maeda, Toyota-shi (JP); Daigo Ando, Nagoya-shi (JP); Yoshikazu Asami, Gotenba-shi (JP); Kenji Itagaki, Suntou-gun (JP); Shunsuke Oyama, Nagakute-shi (JP); Koichiro Muta, Okazaki-shi (JP)

(73) Assignee: TOYOTA JIDOSHA KABUSHIKI KAISHA, Toyota-shi (JP)

(21) Appl. No.: 16/862,023

(22) Filed: Apr. 29, 2020

(30) Foreign Application Priority Data
May 17, 2019 (JP) 2019-093517

(51) Int. Cl. B60W 30/18; B60W 10/188; B60W 10/08

(52) U.S. Cl. CPC B60W 30/18127; B60W 30/18136; B60W 2510/0604; B60W 10/08; B60W 10/188

(57) ABSTRACT

The hybrid vehicle includes an engine having a throttle valve and a forced induction device, a second MG (a motor generator), a drive wheel connected to the engine and the second MG, and a controller (an HV-ECU). While the forced induction device performs boosting, the controller performs a reduction rate restricting process for restricting a target engine torque reduction rate in magnitude to be less than an upper limit rate to prevent a throttle opening degree from rapidly decreasing. Further, the controller performs MG regenerative control for controlling the second MG so that regenerative braking by the second MG compensates for engine brake reduced by the reduction rate restricting process.

This nonprovisional application is based on Japanese Patent Application No. 2019-093517 filed with the Japan Patent Office on May 17, 2019, the entire contents of which are hereby incorporated by reference.

### BACKGROUND

### Field

The present disclosure relates to a hybrid vehicle including an internal combustion engine having a forced induction device and a rotating electric machine as a driving source, and controlling the hybrid vehicle.

### Description of the Background Art

Conventionally, a hybrid vehicle including an internal combustion engine having a forced induction device and a rotating electric machine as a driving source has been known (for example, see Japanese Patent Application Laid-Open No. 2015-58924).

### SUMMARY

In an internal combustion engine having a forced induction device, while the forced induction device performs boosting when the user releases the accelerator pedal and accordingly, the throttle valve's degree of opening is rapidly decreased, then, on one hand, a flow rate of air passing through the compressor of the forced induction device (hereinafter, also referred to as a “flow rate through the compressor”) is rapidly decreased whereas on the other hand, suctioned air pressure on the discharging side of the compressor (hereinafter also referred to as “post-boost suctioned air pressure”) is temporarily maintained at a high level, and accordingly, so-called surging (a phenomenon which generates vibration and noise) may occur in the forced induction device.

One method to avoid surging is known as follows: an intake air bypass passage connecting the compressor's suction and discharging sides and an air bypass valve disposed in the intake air bypass passage are provided, and when the forced induction device performs boosting and the accelerator pedal is also released, the air bypass valve is opened to allow the compressor's discharging side to communicate with the compressor's suction side to decrease post-boost suctioned air pressure. This method, however, requires the intake air bypass passage and the air bypass valve only to avoid surging, resulting in an internal combustion engine increased in size and cost.

As another method to avoid surging may prevent the throttle valve's degree of opening from being rapidly decreased when the accelerator pedal is released while the forced induction device performs boosting. When this method is simply applied, surging can be avoided, however, the internal combustion engine's braking force commensurate with the releasing of the accelerator pedal (i.e., so-called engine braking) is not generated, and the vehicle is not decelerated as the user requests.

The present disclosure has been made in order to solve the above problem, and an object of the present disclosure is to cause deceleration for a vehicle, as the user requests, while avoiding surging of a forced induction device without requiring an intake air bypass passage and an air bypass valve.

(1) According to the present disclosure, a hybrid vehicle comprises: an internal combustion engine having a throttle valve and a forced induction device; a rotating electric machine; a drive wheel connected to the internal combustion engine and the rotating electric machine; and a controller that controls the throttle valve and the rotating electric machine. During boosting by the forced induction device the controller performs: restricting control to restrict a magnitude of a rate of decreasing a degree of opening of the throttle valve to be less than an upper limit value; and regenerative control to control the rotating electric machine to apply regenerative braking force of the rotating electric machine to compensate for an amount by which the braking force of the internal combustion engine is decreased by the restricting control.

(2) In one embodiment, the hybrid vehicle further comprises a hydraulic braking device that hydraulically applies braking force to the drive wheel. When the regenerative braking force by the regenerative control is insufficient to compensate for the braking force of the internal combustion engine decreased by the restricting control, the controller controls the hydraulic braking device to apply hydraulic braking force of the hydraulic braking device to compensate for braking force insufficiently provided by the regenerative braking force.

(3) In one embodiment, the hybrid vehicle does not perform the restricting control and the regenerative control while the forced induction device does not perform boosting.

(4) According to the present disclosure, a control method is a method for controlling a hybrid vehicle comprising an internal combustion engine having a throttle valve and a forced induction device, a rotating electric machine, and a drive wheel connected to the internal combustion engine and the rotating electric machine. The method comprises, during boosting by the forced induction device, performing: restricting control to restrict a magnitude of a rate of decreasing a degree of opening of the throttle valve to be less than an upper limit value; and controlling the rotating electric machine to apply regenerative braking force of the rotating electric machine to compensate for an amount by which the braking force of the internal combustion engine is decreased by the restricting control.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a diagram for illustrating an example of a configuration of a drive system of a hybrid vehicle.

FIG. 2 is a diagram for illustrating an example of a configuration of an engine having a forced induction device.

FIG. 3 is a block diagram representing an example of a configuration of a controller.

FIG. 4 is a diagram for illustrating an operating point of the engine.

FIG. 5 is a diagram schematically representing an example of how the engine changes in state when the accelerator pedal is released while the forced induction device performs boosting.

FIG. 6 is a compressor map for illustrating how the forced induction device's operating point moves when the accelerator pedal is released while the forced induction device performs boosting.

FIG. 7 is a flowchart (part 1) of an example of a process performed by an HV-ECU.

FIG. 8 is a flowchart (part 2) of the example of the process performed by the HV-ECU.

### DESCRIPTION OF THE PREFERRED EMBODIMENTS

Hereinafter, embodiments of the present disclosure will be described in detail with reference to the drawings. In the drawings, identical or corresponding portions are identically denoted and will not be described redundantly.

<Drive System of Hybrid Vehicle>

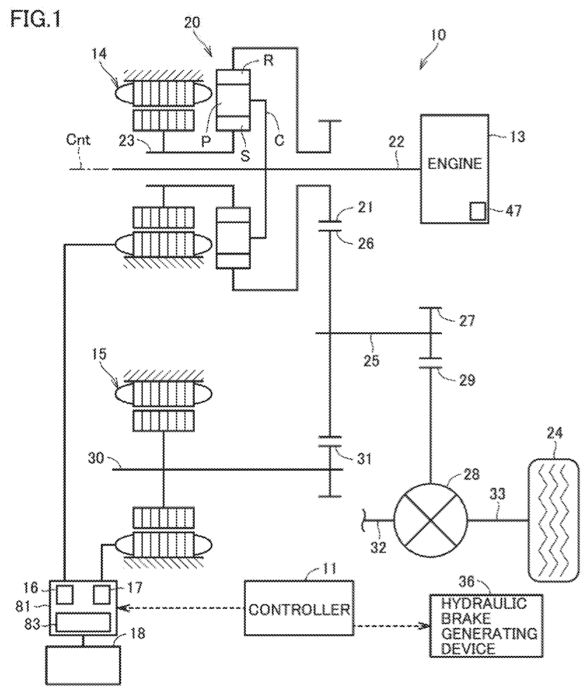

FIG. 1 is a diagram for illustrating an example of a configuration of a drive system of a hybrid vehicle (hereinafter, also simply referred to as “vehicle”) 10. As shown in FIG. 1, vehicle 10 includes an engine (an internal combustion engine) 13 and a second motor generator (a rotating electric machine, hereinafter also referred to as “second MG”) 15 as a power source for traveling. Vehicle 10 further includes a controller 11 and a first motor generator (hereinafter, also referred to as “first MG”) 14.

Engine 13 includes a forced induction device 47. First MG 14 and second MG 15 each perform a function as a motor that outputs torque by being supplied with driving electric power and a function as a generator that generates electric power by being supplied with torque. An alternating current (AC) rotating electric machine is employed for first MG 14 and second MG 15. The AC rotating electric machine includes, for example, a permanent magnet synchronous motor including a rotor having a permanent magnet embedded.

First MG 14 and second MG 15 are electrically connected to a battery 18 with a power control unit (PCU) 81 being interposed. PCU 81 includes a first inverter 16, a second inverter 17, and a converter 83.

For example, converter 83 can up-convert electric power from battery 18 and supply up-converted electric power to first inverter 16 or second inverter 17. Alternatively, converter 83 can down-convert electric power supplied from first inverter 16 or second inverter 17 and supply down-converted electric power to battery 18.

First inverter 16 can convert direct current (DC) power from converter 83 into AC power and supply AC power to first MG 14. Alternatively, first inverter 16 can convert AC power from first MG 14 into DC power and supply DC power to converter 83.

Second inverter 17 can convert DC power from converter 83 into AC power and supply AC power to second MG 15. Alternatively, second inverter 17 can convert AC power from second MG 15 into DC power and supply DC power to converter 83.

PCU 81 charges battery 18 with electric power generated by first MG 14 or second MG 15 or drives first MG 14 or second MG 15 with electric power from battery 18.

Battery 18 includes, for example, a lithium ion secondary battery or a nickel metal hydride secondary battery. The lithium ion secondary battery is a secondary battery in which lithium is adopted as a charge carrier, and may include not only a general lithium ion secondary battery containing a liquid electrolyte but also what is called an all-solid-state battery containing a solid electrolyte. Battery 18 should only be a power storage that is at least rechargeable, and for example, an electric double layer capacitor may be employed instead of the secondary battery.

Engine 13 and first MG 14 are coupled to a planetary gear mechanism 20. Planetary gear mechanism 20 transmits drive torque output from engine 13 by splitting drive torque into drive torque to first MG 14 and drive torque to an output gear 21. Planetary gear mechanism 20 includes a single-pinion planetary gear mechanism and is arranged on an axis Cnt coaxial with an output shaft 22 of engine 13.

Planetary gear mechanism 20 includes a sun gear S, a ring gear R arranged coaxially with sun gear S, a pinion gear P meshed with sun gear S and ring gear R, and a carrier C holding pinion gear P in a rotatable and revolvable manner. Output shaft 22 is coupled to carrier C. A rotor shaft 23 of first MG 14 is coupled to sun gear S. Ring gear R is coupled to output gear 21. Output gear 21 represents one of output elements for transmitting drive torque to a drive wheel 24.

In planetary gear mechanism 20, carrier C to which drive torque output from engine 13 is transmitted serves as an input element, ring gear R that outputs drive torque to output gear 21 serves as an output element, and sun gear S to which rotor shaft 23 is coupled serves as a reaction force element. Planetary gear mechanism 20 divides motive power output from engine 13 into motive power on a side of first MG 14 and motive power on a side of output gear 21. First MG 14 is controlled to output torque in accordance with an engine rotation speed.

A countershaft 25 is arranged in parallel to axis Cnt. Countershaft 25 is attached to a driven gear 26 meshed with output gear 21. A drive gear 27 is attached to countershaft 25, and drive gear 27 is meshed with a ring gear 29 in a differential gear 28 representing a final reduction gear. A drive gear 31 attached to a rotor shaft 30 in second MG 15 is meshed with driven gear 26. Therefore, drive torque output from second MG 15 is added to drive torque output from output gear 21 in a part of driven gear 26. Drive torque thus combined is transmitted to drive wheel 24 with driveshafts 32 and 33 extending laterally from differential gear 28 being interposed. As drive torque is transmitted to drive wheel 24, driving force is generated in vehicle 10.

Further, vehicle 10 includes a hydraulic brake generating device 36. Hydraulic brake generating device 36 operates in response to a command signal issued from controller 11 to utilize hydraulic pressure of liquid (brake fluid) to generate braking force (or hydraulic brake) to be applied to a wheel of vehicle 10 including drive wheel 24.

<Configuration of Engine>

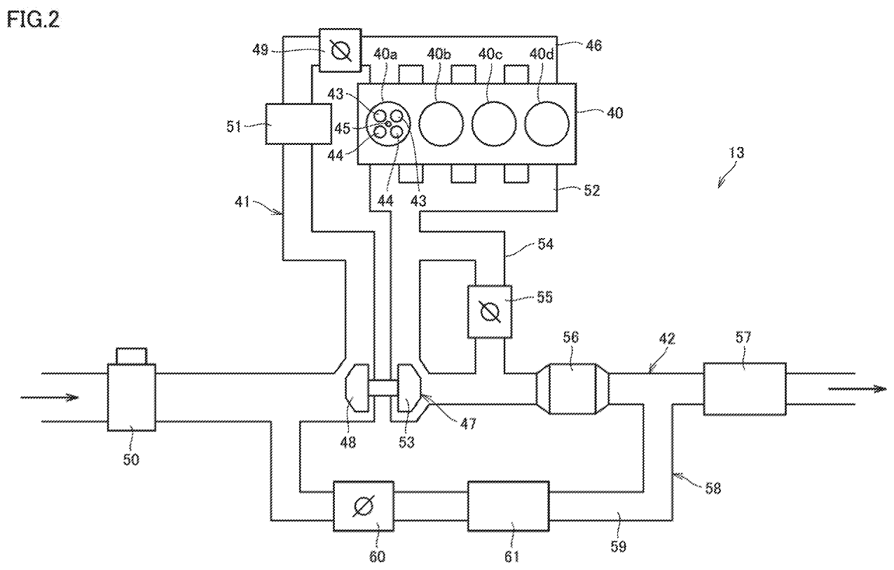

FIG. 2 is a diagram showing an exemplary configuration of engine 13 including forced induction device 47. Engine 13 is, for example, an in-line four-cylinder spark ignition internal combustion engine. As shown in FIG. 2, engine 13 includes, for example, an engine main body 40 formed with four cylinders 40a, 40b, 40c, and 40d being aligned in one direction.

One ends of intake ports and one ends of exhaust ports formed in engine main body 40 are connected to cylinders 40a, 40b, 40c, and 40d. One end of the intake port is opened and closed by two intake valves 43 provided in each of cylinders 40a, 40b, 40c, and 40d, and one end of the exhaust port is opened and closed by two exhaust valves 44 provided in each of cylinders 40a, 40b, 40c and 40d. The other ends of the intake ports of cylinders 40a, 40b, 40c, and 40d are connected to an intake manifold 46. The other ends of the exhaust ports of cylinders 40a, 40b, 40c, and 40d are connected to an exhaust manifold 52.

In the present embodiment, engine 13 is, for example, a direct injection engine and fuel is injected into each of cylinders 40a, 40b, 40c, and 40d by a fuel injector (not shown) provided at the top of each cylinder. An air fuel mixture of fuel and intake air in cylinders 40a, 40b, 40c, and 40d is ignited by an ignition plug 45 provided in each of cylinders 40a, 40b, 40c, and 40d.

FIG. 2 shows intake valve 43, exhaust valve 44, and ignition plug 45 provided in cylinder 40a and does not show intake valve 43, exhaust valve 44, and ignition plug 45 provided in other cylinders 40b, 40c, and 40d.

Engine 13 is provided with forced induction device 47 that uses exhaust energy to boost suctioned air. Forced induction device 47 includes a compressor 48 and a turbine 53.

An intake air passage 41 has one end connected to intake manifold 46 and the other end connected to an air inlet. Compressor 48 is provided at a prescribed position in intake air passage 41. An air flow meter 50 that outputs a signal in accordance with a flow rate of air that flows through intake air passage 41 is provided between the other end (air inlet) of intake air passage 41 and compressor 48. An intercooler 51 that cools intake air pressurized by compressor 48 is disposed in intake air passage 41 provided downstream from compressor 48. A throttle valve 49 that can regulate a flow rate of intake air that flows through intake air passage 41 is provided between intercooler 51 and one end of intake air passage 41.

An exhaust passage 42 has one end connected to exhaust manifold 52 and the other end connected to a muffler (not shown). Turbine 53 is provided at a prescribed position in exhaust passage 42. In exhaust passage 42, an exhaust bypass passage 54 that bypasses exhaust upstream from turbine 53 to a portion downstream from turbine 53 and a waste gate valve 55 provided in the bypass passage and capable of regulating a flow rate of exhaust guided to turbine 53 are provided. Therefore, a flow rate of exhaust that flows into turbine 53, that is, a boost pressure of suctioned air, is regulated by controlling a position of waste gate valve 55. Exhaust that passes through turbine 53 or waste gate valve 55 is purified by a start-up converter 56 and an aftertreatment apparatus 57 provided at prescribed positions in exhaust passage 42, and thereafter emitted into the atmosphere. Aftertreatment apparatus 57 contains, for example, a three-way catalyst.

Engine 13 is provided with an exhaust gas recirculation (EGR) apparatus 58 that has exhaust flow into intake air passage 41. EGR apparatus 58 includes an EGR passage 59, an EGR valve 60, and an EGR cooler 61. EGR passage 59 allows some of exhaust to be taken out of exhaust passage 42 as EGR gas and guides EGR gas to intake air passage 41. EGR valve 60 regulates a flow rate of EGR gas that flows through EGR passage 59. EGR cooler 61 cools EGR gas that flows through EGR passage 59. EGR passage 59 connects a portion of exhaust passage 42 between start-up converter 56 and aftertreatment apparatus 57 to a portion of intake air passage 41 between compressor 48 and air flow meter 50.

Engine 13 is not provided with an intake air bypass passage connecting the suction side of compressor 48 and the discharging side of compressor 48, and an air bypass valve disposed in the intake air bypass passage.

<Configuration of Controller>

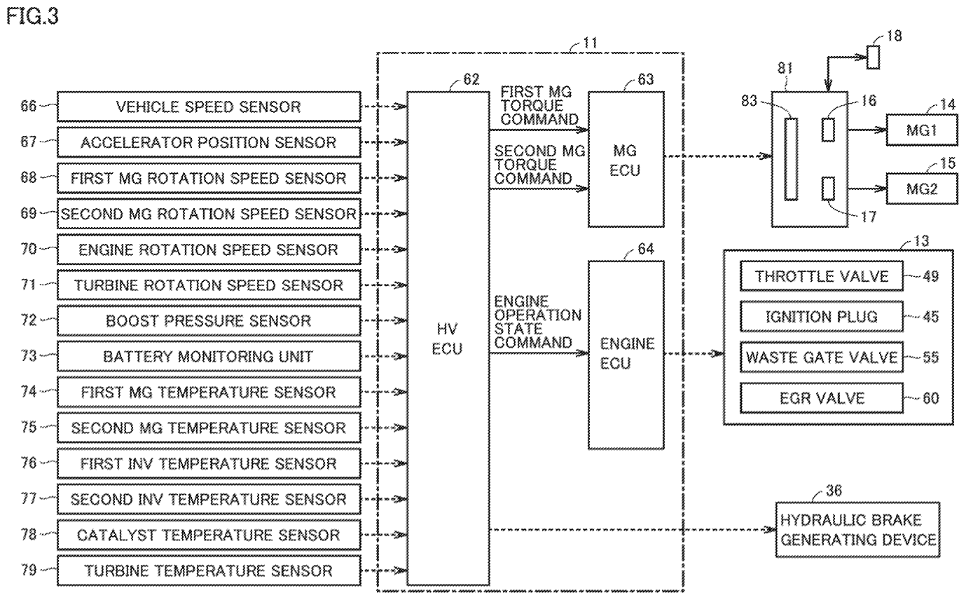

FIG. 3 is a block diagram showing an exemplary configuration of controller 11. As shown in FIG. 3, controller 11 includes a hybrid vehicle (HV)-electronic control unit (ECU) 62, an MG-ECU 63, and an engine ECU 64.

HV-ECU 62 is a controller that controls engine 13, first MG 14, and second MG 15 in coordination. MG-ECU 63 is a controller that controls an operation by PCU 81. Engine ECU 64 is a controller that controls an operation by engine 13.

HV-ECU 62, MG-ECU 63, and engine ECU 64 each include an input and output apparatus that supplies and receives signals to and from various sensors and other ECUs that are connected, a storage that serves for storage of various control programs or maps (including a read only memory (ROM) and a random access memory (RAM)), a central processing unit (CPU) that executes a control program, and a counter that counts time.

A vehicle speed sensor 66, an accelerator position sensor 67, a first MG rotation speed sensor 68, a second MG rotation speed sensor 69, an engine rotation speed sensor 70, a turbine rotation speed sensor 71, a boost pressure sensor 72, a battery monitoring unit 73, a first MG temperature sensor 74, a second MG temperature sensor 75, a first INV temperature sensor 76, a second INV temperature sensor 77, a catalyst temperature sensor 78, and a turbine temperature sensor 79 are connected to HV-ECU 62.

Vehicle speed sensor 66 detects a speed of vehicle 10 (vehicle speed). Accelerator position sensor 67 detects an amount of pressing of an accelerator pedal (accelerator position). First MG rotation speed sensor 68 detects a rotation speed of first MG 14. Second MG rotation speed sensor 69 detects a rotation speed of second MG 15. Engine rotation speed sensor 70 detects a rotation speed of output shaft 22 of engine 13 (engine rotation speed). Turbine rotation speed sensor 71 detects a rotation speed of turbine 53 of forced induction device 47. Boost pressure sensor 72 detects a boost pressure of engine 13. First MG temperature sensor 74 detects an internal temperature of first MG 14 such as a temperature associated with a coil or a magnet. Second MG temperature sensor 75 detects an internal temperature of second MG 15 such as a temperature associated with a coil or a magnet. First INV temperature sensor 76 detects a temperature of first inverter 16 such as a temperature associated with a switching element. Second INV temperature sensor 77 detects a temperature of second inverter 17 such as a temperature associated with a switching element. Catalyst temperature sensor 78 detects a temperature of aftertreatment apparatus 57. Turbine temperature sensor 79 detects a temperature of turbine 53. Various sensors output signals indicating results of detection to HV-ECU 62.

Battery monitoring unit 73 obtains a state of charge (SOC) representing a ratio of a remaining amount of charge to a full charge capacity of battery 18 and outputs a signal indicating the obtained SOC to HV-ECU 62.

Battery monitoring unit 73 includes, for example, a sensor that detects a current, a voltage, and a temperature of battery 18. Battery monitoring unit 73 obtains an SOC by calculating the SOC based on the detected current, voltage, and temperature of battery 18.

Various known approaches such as an approach by accumulation of current values (coulomb counting) or an approach by estimation of an open circuit voltage (OCV) can be adopted as a method of calculating an SOC.

<Control of Running of Vehicle>

Vehicle 10 configured as above can be set or switched to such a running mode as a hybrid (HV) running mode in which engine 13 and second MG 15 serve as motive power sources and an electric (EV) running mode in which the vehicle runs with engine 13 remaining stopped and second MG 15 being driven by electric power stored in battery 18. Setting of and switching to each mode is made by HV-ECU 62. HV-ECU 62 controls engine 13, first MG 14, and second MG 15 based on the set or switched running mode.

The EV running mode is selected, for example, in a low-load operation region where a vehicle speed is low and requested driving force is low, and refers to a running mode in which an operation by engine 13 is stopped and second MG 15 outputs driving force.

The HV running mode is selected in a high-load operation region where a vehicle speed is high and requested driving force is high, and refers to a running mode in which combined torque of drive torque of engine 13 and drive torque of second MG 15 is output.

In the HV running mode, in transmitting drive torque output from engine 13 to drive wheel 24, first MG 14 applies reaction force to planetary gear mechanism 20. Therefore, sun gear S functions as a reaction force element. In other words, in order to apply engine torque to drive wheel 24, first MG 14 is controlled to output reaction torque against engine torque. In this case, regenerative control in which first MG 14 functions as a generator can be carried out.

Control of engine 13, first MG 14, and second MG 15 in coordination while vehicle 10 operates will be described below.

HV-ECU 62 calculates requested driving torque based on an accelerator position determined by an amount of pressing of the accelerator pedal. HV-ECU 62 calculates requested running power of vehicle 10 based on the calculated requested driving torque and a vehicle speed. HV-ECU 62 calculates a value resulting from addition of requested charging and discharging power of battery 18 to requested running power as requested system power. Note that the requested charging and discharging power of battery 18 is set depending on the SOC of battery 18 for example.

HV-ECU 62 determines whether or not activation of engine 13 has been requested in accordance with calculated requested system power. HV-ECU 62 determines that activation of engine 13 has been requested, for example, when requested system power exceeds a threshold value. When activation of engine 13 has been requested, HV-ECU 62 sets the HV running mode as the running mode. When activation of engine 13 has not been requested, HV-ECU 62 sets the EV running mode as the running mode.

When activation of engine 13 has been requested (that is, when the HV running mode is set), HV-ECU 62 calculates power requested of engine 13 (which is denoted as “requested engine power” below). For example, HV-ECU 62 calculates requested system power as requested engine power. HV-ECU 62 outputs calculated requested engine power as an engine operation state command to engine ECU 64.

Engine ECU 64 operates in response to an engine operation state command input from HV-ECU 62 to variously control each component of engine 13 such as throttle valve 49, ignition plug 45, waste gate valve 55, and EGR valve 60.

HV-ECU 62 sets based on calculated requested engine power, an operating point of engine 13 in a coordinate system defined by an engine rotation speed and engine torque. HV-ECU 62 sets, for example, an intersection between an equal power line equal in output to requested engine power in the coordinate system and a predetermined operating line as the operating point of engine 13.

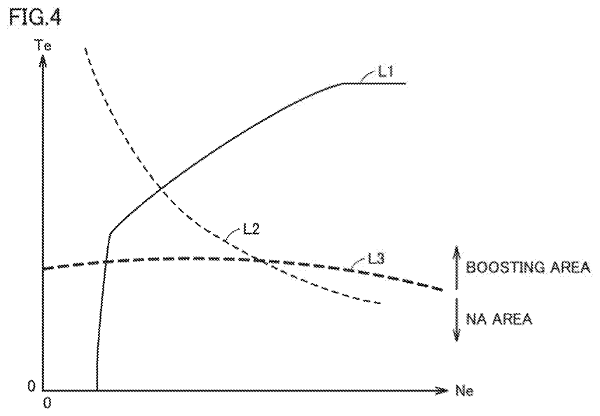

The predetermined operating line represents a trace of variation in engine torque with variation in engine rotation speed in the coordinate system. As will be described hereinafter, in the present embodiment, one of two operating lines (an optimal operating line and a PM suppression operating line shown in FIG. 4) is selectively used as a predetermined operating line.

HV-ECU 62 sets the engine rotation speed corresponding to the set operating point as a target engine rotation speed.

As the target engine rotation speed is set, HV-ECU 62 sets a torque command value for first MG 14 for setting a current engine rotation speed to the target engine rotation speed. HV-ECU 62 sets the torque command value for first MG 14, for example, through feedback control based on a difference between a current engine rotation speed and the target engine rotation speed.

HV-ECU 62 calculates engine torque to be transmitted to drive wheel 24 based on the set torque command value for first MG 14 and sets a torque command value for second MG 15 so as to fulfill requested driving force. HV-ECU 62 outputs set torque command values for first MG 14 and second MG 15 as a first MG torque command and a second MG torque command to MG-ECU 63.

MG-ECU 63 calculates a current value corresponding to torque to be generated by first MG 14 and second MG 15 and a frequency thereof based on the first MG torque command and the second MG torque command input from HV-ECU 62, and outputs a signal including the calculated current value and the frequency thereof to PCU 81.

Further, HV-ECU 62 adjusts a degree of opening of waste gate valve 55 in accordance with the operating point of engine 13 to regulate a flow rate of exhaust that flows into turbine 53 of forced induction device 47, that is, boost pressure for suctioned air through compressor 48.

HV-ECU 62, MG-ECU 63, and engine ECU 64 each include a CPU (Central Processing Unit) and a memory (not shown). Though FIG. 3 illustrates a configuration in which HV-ECU 62, MG-ECU 63, and engine ECU 64 are separately provided by way of example, the ECUs may be integrated as a single ECU.

<Engine Operating Point>

FIG. 4 is a diagram for illustrating an operating point of engine 13. In FIG. 4, the vertical axis represents torque Te of engine 13, and the horizontal axis represents rotation speed Ne of engine 13.

A curve L1 indicates an optimal operating line of engine 13. The optimal operating line is an operating line determined in advance by a preliminary evaluation test, a simulation, or the like so that engine 13 consumes minimum fuel.

A curve L2 is an isopower line of engine 13 corresponding to required power. Since power of engine 13 is a product of the torque Te and the rotation speed Ne, the isopower line L2 is represented by an inversely proportional curve in FIG. 4. By controlling engine 13 so that the operating point of engine 13 is at the intersection of the optimal operating line L1 and the isopower line L2, the fuel consumption of engine 13 corresponding to the requested power is optimized (or minimized).

A curve L3 represents a line at which forced induction device 47 starts boosting (i.e., a boost line). In an NA area where the torque Te of engine 13 is lower than the boost line L3, controller 11 fully opens waste gate valve 55. As a result, exhaust gas flows through exhaust bypass passage 54 without being introduced into turbine 53 of forced induction device 47, so that forced induction device 47 does not provide boosting. On the other hand, in a boosting area where the torque Te exceeds the boost line L3, controller 11 operates waste gate valve 55, having been fully open, in a direction to close it. Thus, turbine 53 of forced induction device 47 is rotated by exhaust energy, and forced induction device 47 performs boosting. By adjusting waste gate valve 55's degree of opening, a flow rate of exhaust gas flowing into turbine 53 of forced induction device 47 can be adjusted, and boost pressure for suctioned air can be adjusted through compressor 48.

<Avoiding Surging of Forced Induction Device>

In engine 13 having forced induction device 47, when forced induction device 47 performs boosting, and the user releases the accelerator pedal and accordingly, throttle valve 49's degree of opening (hereinafter also referred to as “throttle opening degree”) is rapidly decreased, surging may occur in forced induction device 47.

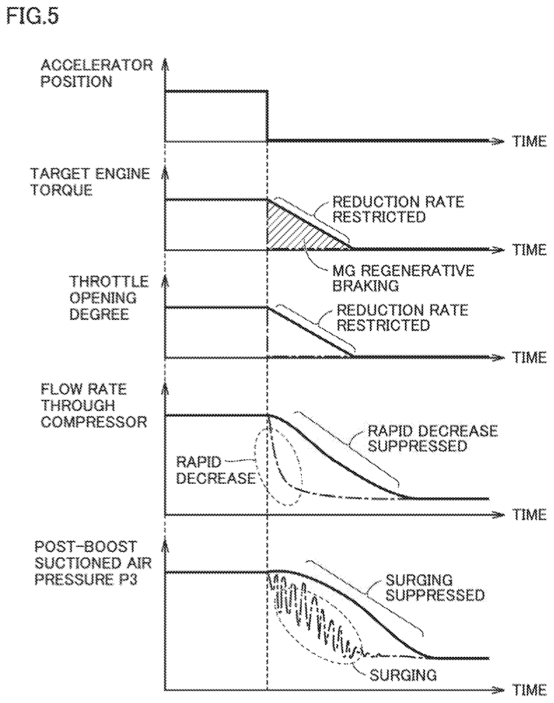

FIG. 5 is a diagram schematically representing an example of how engine 13 changes in state when the accelerator pedal is released while forced induction device 47 performs boosting. In FIG. 5, the horizontal axis represents time and the vertical axis represents from the top an accelerator position, a target engine torque, a throttle opening degree, a flow rate through the compressor (a flow rate of air passing through compressor 48), and a post-boost suctioned air pressure P3 (suctioned air pressure on the discharging side of compressor 48). In the present embodiment, the throttle opening degree is controlled to a value corresponding to the target engine torque for the sake of illustration.

An alternate long and short dash line indicated in FIG. 5 indicates how a state changes when the target engine torque rapidly decreases to zero as the accelerator pedal is released. In that case, as the target engine torque instantaneously decreases to zero, the throttle opening degree also instantaneously decreases to zero. As a result, the flow rate through the compressor rapidly decreases, however, the rotation speed of compressor 48 decreases with a delay, and accordingly, the post-boost suctioned air pressure P3 is temporarily maintained at a high state. Thereby, surging may occur in forced induction device 47. Since the surging is caused by backflow of suctioned air from the discharging side of compressor 48 to the suction side of compressor 48, the post-boost suctioned air pressure P3 is vibrated by the surging, as shown in FIG. 5.

To address this, while forced induction device 47 performs boosting, HV-ECU 62 according to the present embodiment performs a process for restricting a target engine torque reduction rate (or reduction speed) in magnitude to less than a predetermined upper limit rate (hereinafter also referred to as a “target engine torque reduction rate restricting process” or simply a “reduction rate restricting process”). The target engine torque reduction rate restricting process is an example of a process of restricting a rate of decreasing the throttle opening degree to less than an upper limit value. Since the reduction rate restricting process prevents a throttle opening degree from rapidly decreasing, and accordingly, rapid reduction of the flow rate through the compressor is suppressed and surging in forced induction device 47 is avoided. As the reduction rate restricting process prevents the throttle opening degree from rapidly decreasing, braking force of engine 13 commensurate with releasing of the accelerator pedal (so-called engine brake) is not generated, and in view of this, HV-ECU 62 performs a process for controlling second MG 15 so that an amount by which engine brake is reduced by the reduction rate restricting process is compensated for by regenerative braking applied by second MG 15 (hereinafter also referred to as “MG regenerative control”). As a result, a braking force commensurate with an accelerator position can be generated, and vehicular deceleration requested by the user can be caused.

A solid line shown in FIG. 5 represents how a state changes when the above-described reduction rate restricting process and MG regenerative control are performed. In that case, even when forced induction device 47 performs boosting and the accelerator pedal is also released, the reduction rate restricting process prevents the target engine torque from instantaneously decreasing and instead allows it to gradually decrease with an upper limit rate applied, and accordingly, the throttle opening degree is not instantaneously decreased and instead decreased gradually with an upper limit value applied. As a result, the flow rate through the compressor does not rapidly decrease and instead gradually decreases, and accordingly, post-boost suctioned air pressure P3 does not vibrate and surging is thus suppressed.

Further, an amount by which engine brake is decreased by the reduction rate restricting process (see a hatched portion shown in FIG. 5) is compensated for by regenerative braking of second MG 15 by the MG regenerative control. As a result, vehicular braking force commensurate with an accelerator position can be generated to achieve vehicular deceleration requested by the user.

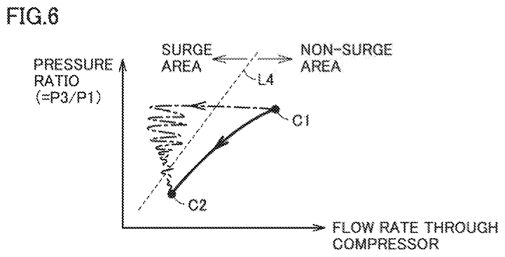

FIG. 6 is a compressor map for illustrating how an operating point of forced induction device 47 moves when the accelerator pedal is released while forced induction device 47 performs boosting. In FIG. 6, the vertical axis represents a pressure ratio of the post-boost suctioned air pressure P3 to pre-boost suctioned air pressure P1 (pressure on the suction side of compressor 48), and the horizontal axis represents the flow rate through the compressor. A dotted line L4 represents a boundary line (a surge line) between a surge area where surging is likely to occur in forced induction device 47 and a non-surge area where surging does not occur. On the compressor map of FIG. 6, the area on the left side of the surge line L4 is the surge area, and the area on the right side of the surge line L4 is the non-surge area. As shown in FIG. 6, the surge line L4 is a line representing a larger pressure ratio for a larger flow rate through the compressor.

In a state in which the operating point of forced induction device 47 is an operating point C1 representing a high pressure ratio in the non-surge area, if the accelerator pedal is released and accordingly the throttle opening degree is instantaneously decreased, the flow rate through the compressor is rapidly decreased, while the rotation speed of compressor 48 is decreased with delay, and accordingly, the post-boost suctioned air pressure P3 is temporarily maintained at a high state. Therefore, the operating point enters the surge area as the flow rate through the compressor rapidly decreases while the pressure ratio does not decrease, as shown by a dot-dashed line indicated in FIG. 6. As a result, surging occurs. Since the surging is caused by backflow of suctioned air from the discharging side of compressor 48 to the suction side of compressor 48, the post-boost suctioned air pressure P3 gradually decreases while vibrating. As a result, the pressure ratio gradually decreases and when it is lower than the surge line L4, the operating point enters the non-surge area and the surging is eliminated.

In contrast, in the present embodiment, in the state where the operating point of forced induction device 47 is the operating point C1, even when the accelerator pedal is released, the reduction rate restricting process restricts a throttle opening degree reduction rate to less than an upper limit value in magnitude. This suppresses a rapid reduction of the flow rate through the compressor, and the operating point will transition to an operating point C2 on the lower pressure ratio side without passing through the surge area. As a result, surging is suppressed.

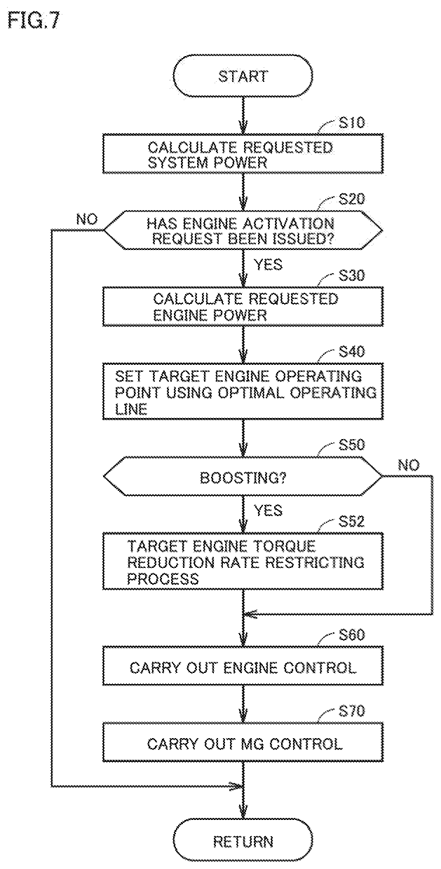

FIG. 7 is a flowchart illustrating an example of a process performed by HV-ECU 62. The process is performed repeatedly whenever a predetermined condition is satisfied (for example, periodically as prescribed).

HV-ECU 62 calculates a requested system power (step S10). Subsequently, HV-ECU 62 determines whether there is a request to operate engine 13 (Step S20). The method of calculating the requested system power and the method of determining a request to operate engine 13 have been described above, and accordingly, will not be described repeatedly.

When it is determined that there is a request to operate engine 13 (YES in step S20), HV-ECU 62 calculates a requested engine power (step S30). HV-ECU 62 calculates, for example, the above requested system power as the requested engine power.

Subsequently, HV-ECU 62 sets a target engine operating point using the optimal operating line L1 shown in FIG. 4 (Step S40). That is, HV-ECU 62 sets an intersection point of the isopower line of the requested engine power and the optimal operating line L1 as the target engine operating point (a target engine torque and a target engine rotation speed). The isopower line and the optimal operating line L1 have been described above, and accordingly, will not be described repeatedly.

Subsequently, HV-ECU 62 determines whether forced induction device 47 currently performs boosting (step S50). For example, when the torque Te of engine 13 exceeds the boost line L3 shown in FIG. 4 (that is, when the engine operating point is in the boosting area), HV-ECU 62 determines that forced induction device 47 currently performs boosting.

When forced induction device 47 currently performs boosting (YES in step S50), HV-ECU 62 performs the above-described target engine torque reduction rate restricting process (step S52). For example, HV-ECU 62 calculates as the current target engine torque reduction rate the currently calculated target engine torque minus the immediately previously calculated target engine torque and divided by a period of time elapsing after the immediately previous calculation before the currently performed calculation. If the current target engine torque reduction rate exceeds the upper limit rate in magnitude, HV-ECU 62 does not apply the currently calculated target engine torque and instead applies the immediately previously calculated target engine torque minus torque of an amount corresponding to the upper limit rate. As a result, the target engine torque will be restricted more than the torque calculated using the optimal operating line L1 in step S40 currently performed. When the current target engine torque reduction rate is equal to or less than the upper limit rate in magnitude, the target engine torque is not restricted. Thereafter, HV-ECU 62 proceeds to step S60.

When boosting is currently not performed (NO in step S50), HV-ECU 62 proceeds to step S60 without performing the target engine torque reduction rate restricting process (i.e., step S52).

Subsequently, HV-ECU 62 performs engine control (step S60). Specifically, HV-ECU 62 generates an engine operation state command so as to output engine power satisfying the target engine operating point, and outputs a signal indicating the generated engine operation state command to engine ECU 64.

Subsequently, HV-ECU 62 performs MG control (step S70). Specifically, HV-ECU 62 generates a torque command value for first MG 14 as a first MG torque command so as to attain the target engine rotation speed. HV-ECU 62 outputs the generated first MG torque command to MG-ECU 63. The above process allows the operating point of engine 13 to be the target operating point.

Furthermore, HV-ECU 62 calculates engine torque to be transmitted to drive wheel 24 based on the torque command value for first MG 14 and generates a torque command value for second MG 15 as the second MG command so as to fulfill requested driving force (that is, so as to generate driving force corresponding to a difference between driving force corresponding to engine torque to be transmitted to drive wheel 24 and requested driving force). HV-ECU 62 outputs the generated second MG torque command to MG-ECU 63. When the target engine torque is restricted by the reduction rate restricting process in step S52, the above-described “MG regenerative control” (a process for compensating for an amount of engine brake that is decreased by the reduction rate restricting process by applying regenerative braking applied by second MG 15) will be implemented by step S70.

If there is no request to operate engine 13 (NO in step S20), HV-ECU 62 stops engine 13 from operating and causes vehicle 10 to run in the EV running mode without performing steps S30 to S70.

Thus, hybrid vehicle 10 according to the present embodiment includes engine 13 having throttle valve 49 and forced induction device 47, second MG 15, drive wheel 24 connected to engine 13 and second MG 15, and HV-ECU 62 (controller 11). While forced induction device 47 performs boosting, HV-ECU 62 performs a “reduction rate restricting process” to restrict a target engine torque reduction rate in magnitude to less than an upper limit rate. The reduction rate restricting process prevents a throttle opening degree from rapidly decreasing, and surging in forced induction device 47 is avoided. Further, HV-ECU 62 performs “MG regenerative control” for controlling second MG 15 to apply regenerative braking by second MG 15 to compensate for an amount of engine brake that is decreased by the reduction rate restricting process. Thus, vehicular deceleration requested by the user can be achieved. As a result, vehicular deceleration requested by the user can be achieved while surging of forced induction device 47 can be avoided without providing an intake air bypass passage and an air bypass valve.

<First Modification>

In the above-described embodiment, an example has been described in which the “MG regenerative control” is performed to control second MG 15 to apply regenerative braking by second MG 15 to compensate for an amount of engine brake that is decreased by the reduction rate restricting process.

However, it is also expected that the regenerative braking applied by second MG 15 may be limited for example by second MG 15 being overheated or battery 18 having high SOC, and an amount of engine brake that is decreased by the reduction rate restricting process may not be compensated for by regenerative braking applied by second MG 15 alone.

In view of this, when the regenerative braking applied by second MG 15 is insufficient for the amount of engine brake that is decreased by the reduction rate restricting process, a hydraulic brake generator may be controlled to apply hydraulic brake to compensate for insufficient braking force applied through regenerative braking.

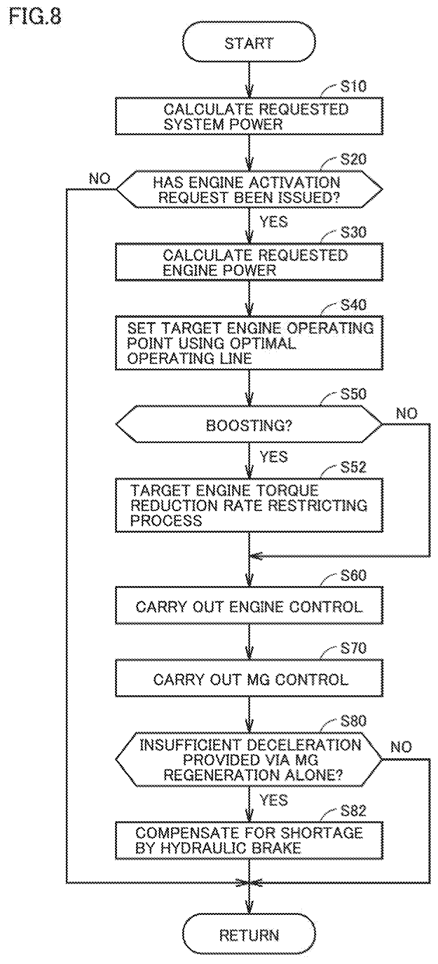

FIG. 8 is a flowchart of an example of a process performed by HV-ECU 62 according to the present modification. The flowchart is obtained by adding steps S80 and S82 to the FIG. 7 flowchart.

That is, HV-ECU 62 determines whether simply applying regenerative braking by second MG 15 provides insufficient vehicular deceleration (step S80). When simply applying regenerative braking by second MG 15 provides insufficient vehicular deceleration (YES in step S80), HV-ECU 62 controls hydraulic brake generator 36 to apply hydraulic brake to compensate for insufficient regenerative braking applied by second MG 15 (Step S82).

Such a modification can more appropriately cause vehicular deceleration requested by the user.

<Second Modification>

While vehicle 10 shown in FIG. 1 is a hybrid vehicle of a type including engine 13 and two MGs 14 and 15 as a driving source (i.e., of a so-called split system), a vehicle to which the presently disclosed control is applicable is not limited to vehicle 10 shown in FIG. 1. For example, the presently disclosed control is applicable to a general series- or parallel-type hybrid vehicle including an engine and a single MG.

Although the embodiments of the present invention have been described, it should be considered that the embodiments disclosed herein are illustrative and non-restrictive in every respect. The scope of the present invention is defined by the terms of the claims, and is intended to include any modifications within the scope and meaning equivalent to the terms of the claims.

What is claimed is:

1. A hybrid vehicle comprising:
an internal combustion engine having a throttle valve and a forced induction device;
a rotating electric machine;
a drive wheel connected to the internal combustion engine and the rotating electric machine; and
a controller that controls the throttle valve and the rotating electric machine, wherein
during boosting by the forced induction device, the controller performs:
restricting control to restrict a magnitude of a rate of decreasing a degree of opening of the throttle valve to be less than an upper limit value; and
regenerative control to control the rotating electric machine to apply regenerative braking force of the rotating electric machine to compensate for an amount by which braking force of the internal combustion engine is decreased by the restricting control.

2. The hybrid vehicle according to claim 1, further comprising a hydraulic braking device that hydraulically applies braking force to the drive wheel, wherein when the regenerative braking force by the regenerative control is insufficient to compensate for the braking force of the internal combustion engine decreased by the restricting control, the controller controls the hydraulic braking device to apply hydraulic braking force of the hydraulic braking device to compensate for braking force insufficiently provided by the regenerative braking force.

3. The hybrid vehicle according to claim 1, wherein the hybrid vehicle does not perform the restricting control and the regenerative control while the forced induction device does not perform boosting.

4. A method for controlling a hybrid vehicle comprising:
an internal combustion engine having a throttle valve and a forced induction device,
a rotating electric machine, and
a drive wheel connected to the internal combustion engine and the rotating electric machine, the method comprising:
during boosting by the forced induction device, performing:
restricting control to restrict a magnitude of a rate of decreasing a degree of opening of the throttle valve to be less than an upper limit value; and
controlling the rotating electric machine to apply regenerative braking force of the rotating electric machine to compensate for an amount by which braking force of the internal combustion engine is decreased by the restricting control.
